(19) United States
(12) Patent Application Publication
(10) Pub. No.: US 2013/0221750 A1
(43) Pub. Date: Aug. 29, 2013

(54) ACTIVE BACK UP AUTO CHANGEOVER VOLTAGE BUS

(71) Applicant: Radhakrishna TOGARE, Vancouver, WA (US)

(72) Inventor: Radhakrishna TOGARE, Vancouver, WA (US)

(73) Assignee: LSI Corporation, Milpitas, CA (US)

(21) Appl. No.: 13/594,888

(22) Filed: Aug. 27, 2012

Related U.S. Application Data
(63) Continuation of application No. 12/464,106, filed on May 12, 2009, now abandoned.

(51) Int. Cl. H02J 9/06

(52) U.S. Cl. CPC H02J 9/06
USPC 307/65

(57) ABSTRACT

Several methods and a system to implement an efficient power supply management are disclosed. In one embodiment, an apparatus of a voltage supply includes a power supply providing a voltage. The apparatus includes an active supply module communicating with a supply voltage to a voltage bus through an ORing element. The apparatus also includes a redundant supply module providing an additional voltage to the voltage bus if the active supply module fails, through an additional ORing element. The redundant supply module may be coupled with the power supply in parallel with the active supply module. Further, the apparatus includes an automatic changeover module detecting a failure of the active supply module disabling the active supply module and enabling the redundant supply module to supply the additional voltage supply to the voltage bus. Further, the apparatus also includes a voltage bus coupled with a load.

### CLAIM FOR PRIORITY

This application is a continuation of U.S. Utility patent application Ser. No. 12/464,106, titled “ACTIVE BACK UP AUTO CHANGEOVER VOLTAGE BUS” filed on May 12, 2009.

### FIELD OF TECHNOLOGY

This disclosure relates generally to fields of electronics and electrical technology, and more particularly to a power supply management.

### BACKGROUND

A voltage bus may be powered by a number of voltage supplies. The voltage supplies may be in parallel. If a particular voltage supply fails another voltage supply may be activated. For example, the particular voltage supply may be in an active state and the other voltage supply may be in an inactive state to conserve power. However, activation of the other voltage supply may take a period of time. During the period of time, the voltage to the voltage bus may be interrupted. A load of the voltage bus may be damaged as a result of the interruption of the voltage to the voltage bus.

### SUMMARY

This summary is provided to comply with 37 C.F.R. §1.73, requesting a summary of the invention briefly indicating the nature and substance of the invention. It is submitted with the understanding that it will not be used to limit the scope or meaning of the claims.

Several methods and system to implement efficient management of power supply are disclosed.

In an exemplary embodiment, an apparatus of a voltage supply includes a power supply providing a voltage. The apparatus includes an active supply module communicating with a supply voltage to a voltage bus through an ORing element. The active supply module may be coupled with the power supply. The apparatus also includes a redundant supply module providing an additional voltage to the voltage bus if the active supply module fails, through an additional ORing element. The redundant supply module may be coupled with the power supply in parallel with the active supply module. Further, the apparatus includes an automatic changeover module detecting a failure of the active supply module disabling the active supply module and enabling the redundant supply module to supply the additional voltage supply to the voltage bus. Furthermore, the apparatus also includes a voltage bus coupled with a load. The active backup module may be provided through a supplemental ORing element, a backup voltage to the voltage bus if the overall voltage value of the voltage bus decreases below a specified voltage value. The active backup module may include a power source.

In an exemplary embodiment, a method of a voltage supply includes communicating a supply voltage to a voltage bus through an ORing element. The voltage supply may detect a failure to communicate to the voltage bus through the ORing element. The voltage supply may disable the communication to the voltage bus through the ORing element. Further, the method includes transmitting another supply voltage to the voltage through another ORing element in parallel to the ORing element. In addition, the method includes supplying an additional voltage to the voltage bus through an additional ORing element if a communication of the supply voltage through the ORing element fails. The method also includes providing a backup voltage to the voltage bus through a supplemental ORing element if the overall voltage value of the voltage bus decreases below a specified voltage value.

An exemplary embodiment includes a system of voltage supply. The system of a voltage supply includes a voltage supply unit providing a voltage to an active supply and/or a redundant supply. The voltage supply may also include an active supply to supply the voltage to a load via a bus. Further, the system includes a redundant supply providing the voltage to the load if the active supply is disabled. The system also includes a control module to determine a failure of the active supply, to automatically disable the active supply and to enable the redundant supply if the active supply is disabled. Further, the system also includes an active backup supply providing an additional voltage with an ORing element to the load via the bus. The active backup supply may be provided during a period of an automatic disabling of the active supply until an enabling of the redundant supply. The additional voltage may be less than the voltage to the load supplied by the active supply.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view illustrating active power supplies providing power to a load connected to a voltage bus, according to one embodiment.

FIG. 2 is a system view illustrating a supply of power to a voltage bus under normal operating conditions, according to one embodiment.

FIG. 3 is a system view illustrating transition of active power supply to an inactive state, according to one embodiment.

FIG. 4 is a system view illustrating activation of a redundant supply module, according to one embodiment.

FIG. 5 is a process flow illustrating management of a supply voltage, according to another embodiment.

Other features of the present embodiments will be apparent from the accompanying drawings and from the detailed description that follows.

### DETAILED DESCRIPTION

Several systems and a method for an active backup auto changeover voltage bus are disclosed.

Although the present embodiments have been described with reference to specific example embodiments, it will be evident that various modifications and changes may be made to these embodiments without departing from the broader spirit and scope of the various embodiments.

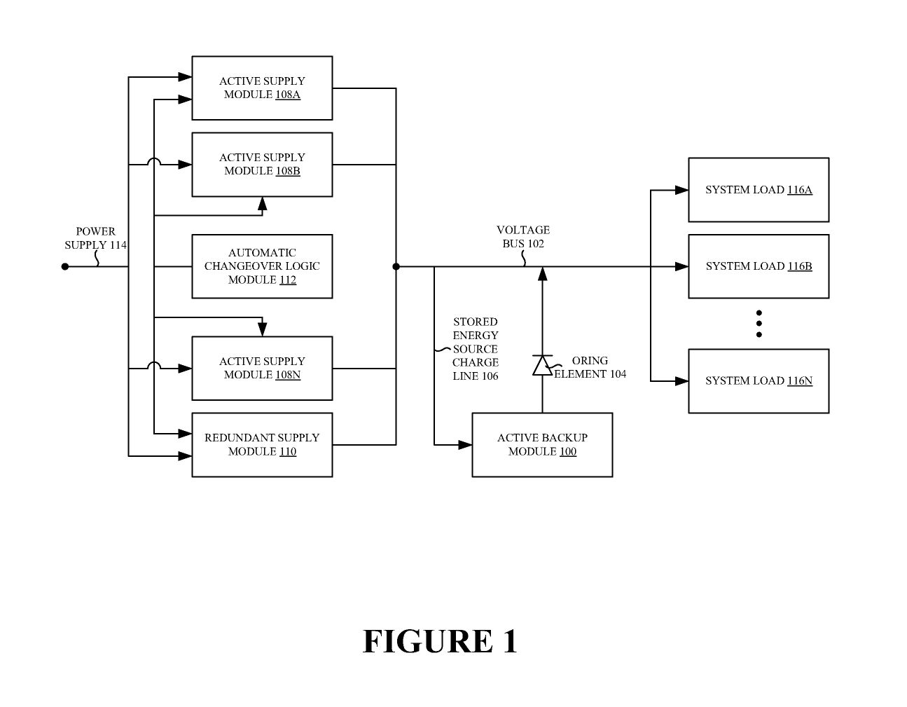

FIG. 1 is a system view illustrating active power supplies providing power to a load connected to a voltage bus, according to one embodiment. In particular, FIG. 1 illustrates an active backup module 100, a voltage bus 102, an ORing element 104, a stored energy charge line 106, an active supply module 108A-N, a redundant supply module 110, an automatic changeover module 112, a power supply 114 and a system load 116A-N, according to one embodiment.

The power supply 114 may be any source of power. In other embodiments, it may be a voltage or a current input. The source of electrical power may be a as rectifier, inverter, linear regulator, switching power supply, a transformer, a generator or an alternator.

An active supply module 108A-N includes a source of electrical power. The system load 116A-N is a device that receives electrical power. The active supply module 108A-N may be implemented in hardware and software or in other example embodiments in hardware alone.

The active backup module 100 provides a voltage to the system load 116A-N. The active backup module 100 includes a power supply that supplies power to the voltage bus 102 during a period when the voltage value of the voltage bus 102 drops below a specified level. The transition may occur during a switching of an active supply module 108 to a redundant supply module 110. During the transition, the power to the system load 116A-N may be provided by the active supply module 108B and active supply module 108N.

The automatic changeover module 112 includes both firmware and software functionalities. The automatic changeover module 112 may be coupled with a server in other example embodiments. The automatic changeover module 112 detects a failure of the active supply module 108A, disables the active supply module 108A and enables the redundant supply module 110 to supply the additional voltage supply to the voltage bus 102. For example, in a particular example embodiment, the switching of one or more power supply from active state to an inactive state may occur with the help of automatic changeover module 112. The active supply module 108A-N generates the required voltage from the power supply 114. The automatic changeover module 112 detects the failure of the active supply module 108A-N. The automatic changeover module 112 may be implemented in hardware and software or in other example embodiments in hardware alone. The active supply module 108A-N and/or the redundant supply module 110 are voltage sources that may be designed to supply the power requirement to the system load 116A-N in an entity.

The redundant supply module 110 is coupled in series with the power supply 114 and in parallel with the active supply module 108A-N. If the active supply module 108 fails the automatic logic changeover module 112 deactivates the active supply module 108. The automatic logic changeover module 112 then activates the redundant supply module 110. In other example embodiments, there may be a plurality of redundant supply modules.

The voltage bus 102 is a medium (e.g., a wire, a cable) for transfer of power from the power supply 114 to the system load 116A-N. The voltage bus 102 may be coupled to the system load 116A-N.

The active backup module 100 provides additional backup power to the system load 116A-N during an event of failure of one or more active supply modules 108A-N and during the period of activation of the redundant supply module 108. The active backup module 100 provides surge power if the overall voltage of the voltage bus 102 drops below a threshold voltage value.

The ORing operation is achieved with the ORing element 104. An ORing element 104 may be an ORing diode, an ORing Mosfet and/or any other semiconductor device utilizing OR logic.

The stored energy charge line 106 couples the voltage bus 102 to a battery included in the active backup module 100. The stored energy charge line 106 recharges a battery.

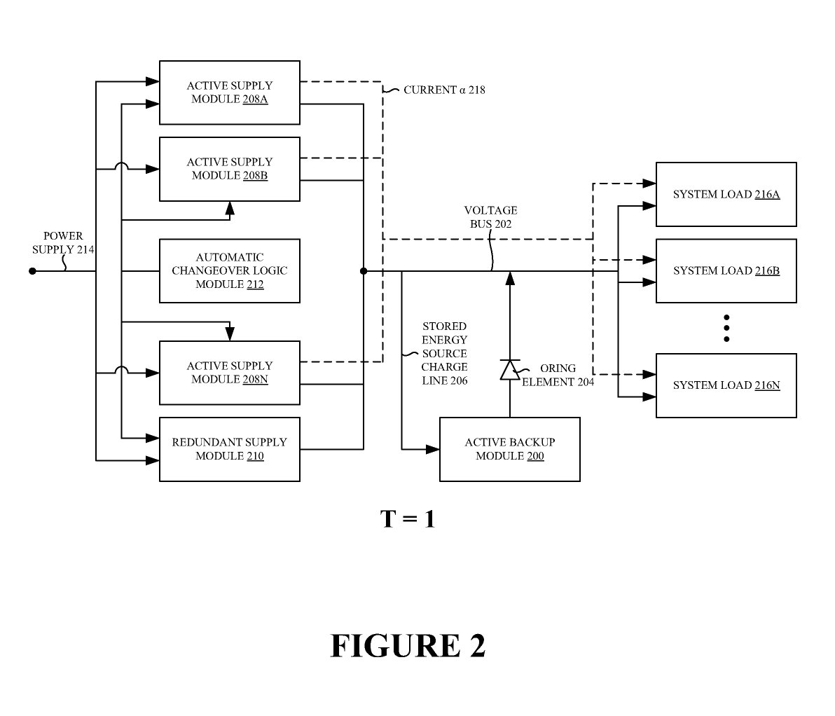

FIG. 2 is a system view illustrating a supply of power to a voltage bus under normal operating conditions, according to one embodiment. In particular, FIG. 2 illustrates an active backup module 200, a voltage bus 202, an ORing element 204, a stored energy charge line 206, an active supply module 208A-N, a redundant supply module 210, an automatic changeover module 212, a power supply 214, a system load 216A-N and a current α 218, according to one embodiment.

In the example embodiment, the active supply module 208A-N generates the current a 218 required for the system load 216A-N at an instance T=1. The active supply module 208A is in an active state of generating power to the voltage bus 202. During normal operating condition, a redundant supply module 210 is in an inactive state and does not consume power. The redundant supply module 210 is in a non-operating condition and does not provide the load power. The redundant supply module 210 remains in a non-operating condition when the active supply module 208A-N is operating. The active backup module 200 does not yet provide the backup voltage to the voltage bus 202 during an activation period of the redundant supply module 210 as the current α 218 maintains a sufficient voltage value in voltage bus 202.

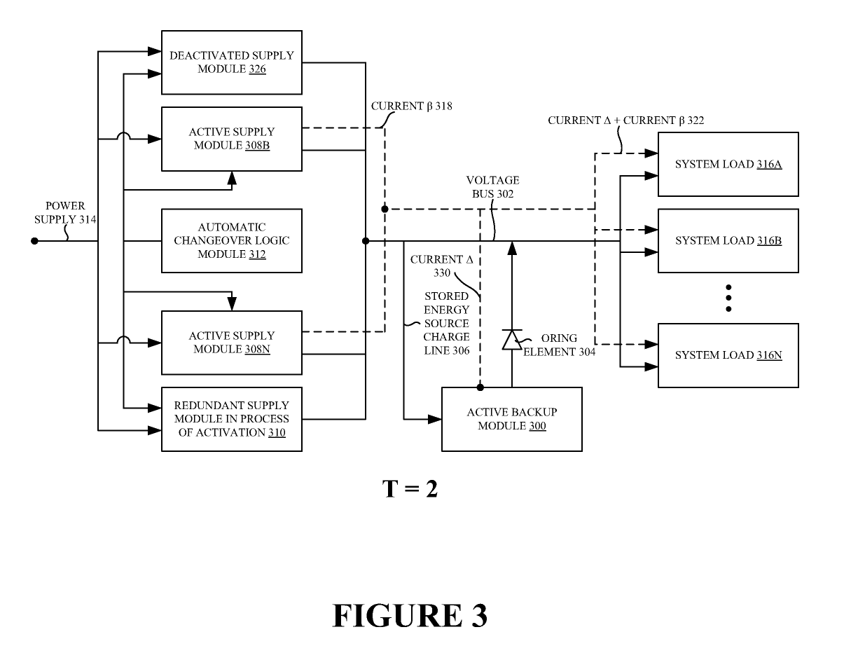

FIG. 3 is a system view illustrating transition of active power supply to an inactive state, according to one embodiment. In particular, FIG. 2 illustrates an active backup module 300, a voltage bus 302, an ORing element 304, a stored energy charge line 306, a deactivated supply module 326 an active supply module 308B-N, a redundant supply module 310, an automatic changeover module 312, a power supply 314, a system load 316A-N, current β 318, current Δ 330, and the sum of current β and current Δ 322, according to one embodiment.

In an example embodiment, the active supply module 308B generates the current β. The active supply module 308A may be in an inactive state at an instance T=2. The automatic changeover module 312 has disabled the deactivated supply module 326 which has failed. The redundant supply module 310 is in the process of being activated. The current β 318 is generated by the active supply module 308B and active power supply 308 N. The current β 318 does not include any current from the deactivated supply module 326 and therefore is now less than current α 218 of FIG. 2. Thus, there is a voltage value in the voltage bus 302 that is less than the specified value. The active backup module 300 is automatically activated and provides a backup voltage to the voltage bus 302. This is represented by the current Δ 330. In this particular embodiment, current Δ 330 is the difference between in the current α 218 and current β 318. Consequently, the voltage supplied to the system load 216 remains substantially constant during the activation of the redundant voltage supply module 210 despite the failure of deactivated supply module 326.

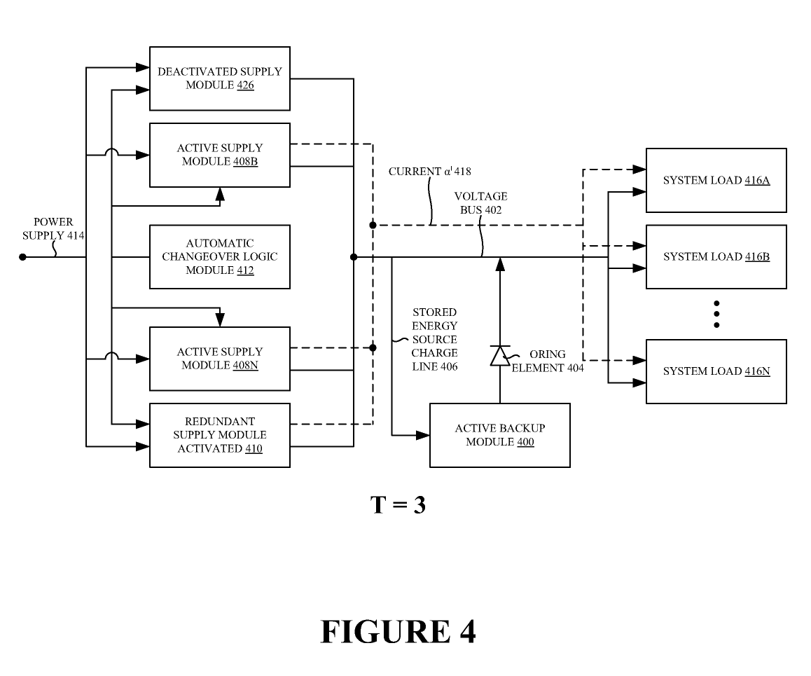

FIG. 4 is a system view illustrating activation of a redundant supply module, according to one embodiment. In particular, FIG. 4 illustrates an active backup module 400, a voltage bus 402, an ORing element 404, a stored energy charge line 406, an active supply module 408B-N, a redundant supply module 410, an automatic changeover module 412, a power supply 414, a system load 416A-N, current α′ 418 and a deactivated supply module 426.

In an example embodiment, the current α′ 420 is generated by active supply module 408B, active supply module 408 N and the redundant supply module 410. The operation occurs at an instance T=3 which represents the time after the redundant supply module 410 has been activated. Current α′ 420 is greater than the specified threshold for activating the active backup module 400. Current α′ 420 is substantially equal to Current α 218 of FIG. 2. Consequently, the active backup module 400 is no longer supplying a voltage to the voltage bus 402 at T=3.

The currents of FIGS. 2-4 may be represented by power and/or voltage values in other example embodiments.

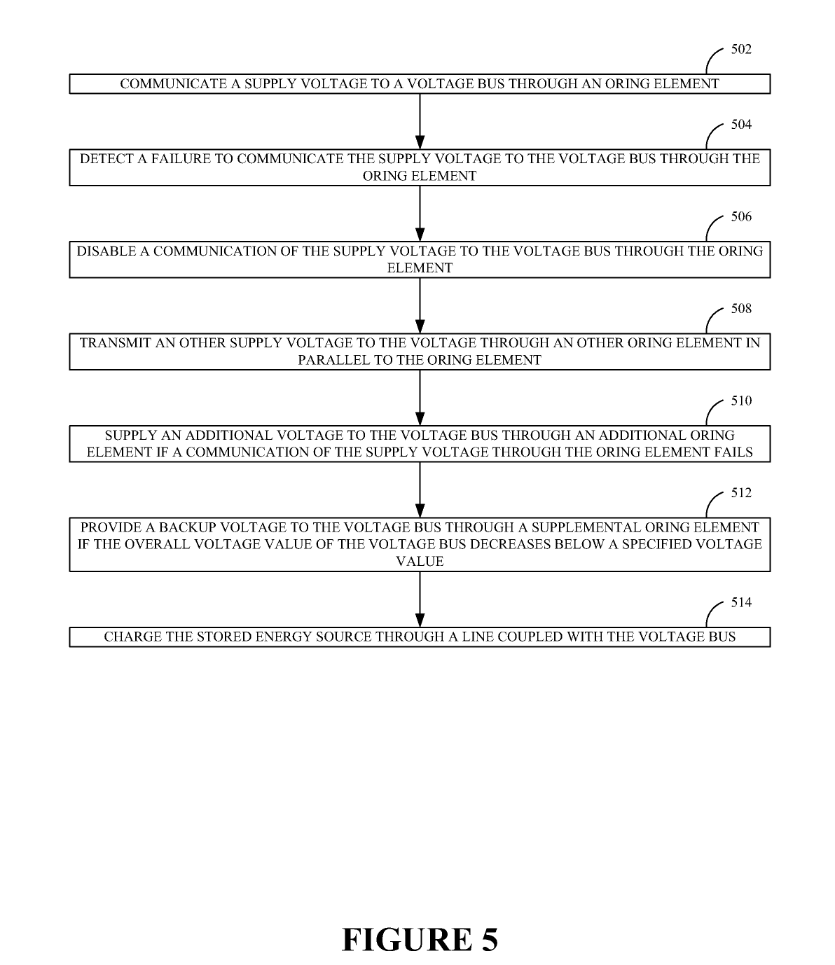

FIG. 5 is a process flow illustrating management of a supply voltage, according to another embodiment. In operation 502, a supply voltage to the voltage bus 102 communicates through the ORing element 104. The ORing operation is a selection of power from any of the active supply module 108A-N and the redundant supply module 110. In operation 504, a failure to communicate the supply voltage to the voltage bus 102 through the ORing element 104 is detected. For example, the automatic changeover module 112 detects the failure to communicate the supply voltage to the voltage bus 102. In operation 506, a communication of the supply voltage to the voltage bus 102 is disabled through the ORing element 104. The automatic changeover module 112 may perform this operation.

In operation 508, another supply voltage is transmitted to the voltage bus 102 through an other ORing element in parallel to the ORing element 104. In operation 510, an additional voltage to the voltage bus 102 through the other ORing element 104 is supplied if a communication of the supply voltage through the ORing element 104 fails. In operation 512, a backup voltage to the voltage bus 102 through a supplemental ORing element is provided if the overall voltage value of the voltage bus 102 decreases below a specified voltage value. In operation 514, the stored energy source is charged through a line coupled with the voltage bus 102. For example, the stored energy charge line 106 may a battery that serves as the stored energy source of the active backup module 100. FIG. 1-FIG. 4 provides example structures for performing operation 502 through operation 514.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the invention may be enabled using software and/or using transistors, logic gates, and electrical modules (e.g., application specific integrated ASIC circuitry) such an active backup module, an active supply module, a redundant supply module, an automatic changeover module and other module.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. An apparatus comprising:
at least one active supply module to communicate an appropriate supply voltage to a voltage bus coupled to a load;
a redundant supply module to provide the appropriate supply voltage to the voltage bus if the at least one active supply module fails, the redundant supply module being coupled in parallel with the at least one active supply module, and the redundant supply module being held in an inactive state until the failure of the at least one active supply module;
an automatic changeover module to detect the failure of the at least one active supply module, to disable the at least one active supply module upon the failure thereof and to enable the redundant supply module to supply the appropriate supply voltage to the voltage bus upon the failure of the at least one active supply module; and
an active backup module to provide, through an ORing element the appropriate voltage to the voltage bus solely during an automatic power supply transition from the at least one active supply module to the redundant supply module upon the failure of the at least one active supply module such that a current associated with the active backup module during the provision of the appropriate voltage to the voltage bus is equal to a difference between a current associated with the at least one active supply module during the provision of the appropriate voltage to the voltage bus and a current associated with the redundant supply module during the provision of the appropriate voltage to the voltage bus, the active backup module comprising a stored energy source to enable provision of power therefrom.

2. The apparatus of claim 1,
wherein the stored energy source is a battery power source configured to maintain the active backup module in an active state.

3. The apparatus of claim 1, wherein the automatic changeover module includes at least one of a firmware and a software functionality associated therewith.

4. The system of claim 18, wherein the active backup supply is additionally configured to provide surge power to the voltage bus when a voltage of the voltage bus drops below a threshold value.

5. The apparatus of claim 1, wherein the at least one active supply module and the redundant supply module are voltage sources.

6. The apparatus of claim 1, wherein the ORing element is a diode.

7. The apparatus of claim 1, wherein the active backup module is additionally configured to provide surge power to the voltage bus when a voltage of the voltage bus drops below a threshold value.

8. The apparatus of claim 2, further comprising:
a stored energy charge line to couple the voltage bus with the battery power source and to charge the battery power source.

9. A method comprising:
coupling a redundant supply module in parallel with at least one active supply module configured to communicate an appropriate supply voltage to a voltage bus coupled to a load;
maintaining the redundant supply module in an inactive state when the at least one active supply module communicates the appropriate supply voltage to the voltage bus;
detecting a failure of the at least one active supply module through an automatic changeover module;
disabling the failed at least one active supply module through the automatic changeover module;
enabling, through the automatic changeover module, the redundant supply module to communicate the appropriate voltage to the voltage bus upon the failure of the at least one active supply module; and
configuring, through an ORing element, an active backup module to provide the appropriate voltage to the voltage bus solely during an automatic power supply transition from the at least one active supply module to the redundant supply module upon the failure of the at least one active supply module such that a current associated with the active backup module during the provision of the appropriate voltage to the voltage bus is equal to a difference between a current associated with the at least one active supply module during the provision of the appropriate voltage to the voltage bus and a current associated with the redundant supply module during the provision of the appropriate voltage to the voltage bus.

10. The method of claim 9, comprising configuring the active backup module to provide the appropriate voltage to the voltage bus through a stored energy source.

11. The method of claim 9, wherein the automatic changeover module includes at least one of a firmware and a software functionality associated therewith.

12. The system of claim 18, wherein the control module includes at least one of a firmware and a software functionality associated therewith.

13. The method of claim 9, wherein the at least one active supply module and the redundant supply module are voltage sources.

14. The method of claim 10, further comprising:
charging the stored energy source through a line coupled with the voltage bus.

15. The method of claim 9, further comprising additionally configuring the active backup module to provide surge power to the voltage bus when a voltage of the voltage bus drops below a threshold value.

16. The method of claim 9, wherein the ORing element is a diode.

17. The method of claim 9, comprising coupling the ORing element between the active backup module and the voltage bus.

18. A system comprising:
a voltage bus;
a load coupled to the voltage bus;
an active supply to provide an appropriate voltage to the voltage bus;
a redundant supply coupled to the active supply in parallel, the redundant supply being configured to provide the appropriate voltage to the voltage bus upon a failure of the active supply, the redundant supply being in an inactive state when the active supply provides the appropriate voltage to the voltage bus
a control module to determine the failure of the active supply, to automatically disable the active supply upon the detection of the failure thereof and to enable the redundant supply if the active supply is disabled; and
an active backup supply to provide the appropriate voltage to the voltage bus through an ORing element associated therewith solely during an automatic power supply transition from the active supply to the redundant supply upon a failure of the active supply such that a current associated with the active backup supply during the provision of the appropriate voltage to the voltage bus is equal to a difference between a current associated with the active supply during the provision of the appropriate voltage to the voltage bus and a current associated with the redundant supply during the provision of the appropriate voltage to the voltage bus.

19. The system of claim 18, wherein the active backup supply includes a stored energy source associated therewith to enable provision of power therefrom.

20. The system of claim 18, wherein the ORing element is a diode.
